(19) United States
(12) Patent Application Publication
(10) Pub. No.: US 2008/0115170 A1
(43) Pub. Date: May 15, 2008

(54) METHODS AND APPARATUS FOR RECORDING AND SHARING BROADCAST MEDIA CONTENT ON A WIRELESS COMMUNICATION DEVICE

(75) Inventors: Rajarshi Ray, San Diego, CA (US); Premkumar Jothipragasam, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 11/554,536

(22) Filed: Oct. 30, 2006

(51) Int. Cl. H04N 5/445; G06F 3/00; G06F 13/00; H04N 7/16

(52) U.S. Cl. 725/58; 725/62

(57) ABSTRACT

Methods and apparatus are presented for recording broadcast media content at a wireless communication device and, in some aspects, sharing the recorded broadcast media content with other wireless communication devices. The disclosed aspects capture broadcasted media content at predetermined times by implementing a clock function that launches the capture and record module at the predetermined time. In certain aspects, the device incorporates a search function that allows for the predetermined selection of media content criteria that is used to search and determine the media content that is encoded and stored for subsequent use and/or sharing. In other aspects, the recorded broadcast media content is shared with other wireless communication devices by encoding the recorded/stored media content in a speech-format and communicating the speech-formatted media content to other wireless devices.

### REFERENCE TO CO-PENDING APPLICATION FOR PATENT

The present Application for Patent is related to the following co-pending U.S. patent application: “Methods and Apparatus for Communicating Media Files Amongst Wireless Communication Devices” by Rajarshi Ray et al., having Attorney Docket No. 060946, filed concurrently herewith, assigned to the assignee hereof, and expressly incorporated by reference herein.

### BACKGROUND

The disclosed aspects relate to wireless communication devices, and more particularly, to systems and methods for recording and sharing broadcast media content on wireless communication devices.

Wireless communication devices, such as cellular telephones, have rapidly gained in popularity over the past decade. These devices are rapidly becoming multifaceted devices capable of providing a wide-range of functions. For example, a cellular telephone may also embody computing capabilities, Internet access, electronic mail, text messaging, GPS mapping, digital photographic capability, an audio/MP3 player, video gaming capabilities, video broadcast reception capabilities and the like.

The cellular telephone that also incorporates an audio/MP3 player and/or a video player and/or a video game player is becoming increasingly popular, especially amongst a younger age demographic of device users. Such a device provides an advantage over the stand-alone audio/MP3 player device, video player device or video gaming device in that cellular communication provides an avenue to download songs, videos or video games directly to the wireless device without having to first download the songs, videos or games to a personal computer (PC), laptop computer or other device with an Internet connection and then transfer it from that device to the wireless device through an universal serial bus (USB) cable or the like. This ability to instantaneously obtain media files (e.g., songs, CDs, videos, movies, games, pictures, graphics or the like) is very attractive to users who regularly demand the media at the spur of the moment.

In addition to audio/MP3 players, video players and/or video game players, cellular telephones and other wireless communication devices are commonly equipped with broadcast receivers, such as AM and/or FM radio receivers. In this same regard, technological advancements in networking capabilities will make it commonplace in the near future for such devices to incorporate television broadcast receivers for receiving broadcasted television content and/or other broadcasted or streaming multimedia content, such as movies/videos, video games or the like. Broadcasted media content, such as radio content or television content, is generally broadcasted on a scheduled basis. As such, in most instances a user is aware, in advance, of scheduled broadcasts. For example, a specific radio station may broadcast a certain format of music at a specific time period during the day and/or week, or television stations may broadcast specific programs at specific scheduled time periods.

Broadcasting or streaming of content allows for a device to receive a one-way transmission of media over a data network. Such transmissions are widely used on the Intranet to deliver media content on-demand or an audio/video broadcast, such as Intranet radio or the like. Unlike conventional multimedia fries (such as audio WAV, MP3 files, video MPEG tiles etc.) that are played after they are downloaded, streaming audio/video is played within a few seconds of requesting it, and the data typically is not stored permanently on the receiving device. In this regard, the broadcast or streaming content is not captured, converted to a compressed state suitable for permanent storage and/or stored on the device for subsequent playing/executing in the future.

In addition to obtaining media on-demand and in a mobile environment, many users enjoy being able to instantaneously share media files with friends, colleagues and the like. Wireless handset-to-wireless handset sharing of media files, however, provides many problems. One of the problems related to sharing media files is that the files are typically protected by copyright laws, which forbid the sharing of media files without acquiring requisite license (e.g., paying a licensing fee). However, many media content providers are allowing users to share media files if the media file is somewhat limited or altered, such that the shared media file does not provide the same user experience as the original unaltered file. These limited or altered media files generally fall in the category of promotional copies offered by the media providers. The concept benefits from the user of the shared media file hopefully being enticed into purchasing an unaltered or “clean” copy of the file. Altering or limiting the media file may include limiting the amount of “plays,” providing a shared copy of a degraded quality or providing only a portion, of the file, commonly referred to as a snippet that is made available by content providers for promotional purposes, for example, to promote a new artist or a new album.

Another problem with wireless handset-to-wireless handset sharing of media files is that the files tend to be large in size and therefore sharing the file over the cellular network is not readily feasible, especially over a 2G (second generation) cellular network, as used in the majority of the developing countries in the world. For example, a compressed 4-minute MP3 format audio file is approximately 3.5 MB (mega bytes) in size. Even more advanced compression techniques, such as implemented in Advanced Audio Coding Plus (AAC+), result in a corresponding audio file approximately 700 KB (kilobytes) in size. Further, song files are relatively small in size compared to video files and video game files. Thus, such large file sizes make any of the current cellular network data transfer methods either impractical, because it takes too long to download such files and it consumes a large section of the network capacity, or incapable of reliably transferring the file from one wireless handset to another.

Therefore a need exists to develop methods and apparatus for recording and, in some aspects, sharing broadcast media content at a wireless communication device.

### SUMMARY

The disclosed apparatus and methods provide for the recording and, in some aspects, sharing of broadcasted media content in wireless communication devices. IN some aspects, the method and apparatus may take into account the scheduled program nature of broadcast media content, thereby allowing users to schedule in advance the recording of a scheduled broadcast. In other aspects, the methods and apparatus may address the fact that broadcast media is formatted to allow for on-demand playing/execution, but is not readily formatted for permanent storage at the wireless device. Further, in yet other aspects, the apparatus and methods may provide for the user to designate recorded broadcast media content for sharing amongst other wireless communication devices. For example, the desired sharing designation may occur prior to capturing and storing broadcast media content or it may occur after the media content has been broadcasted and recorded. Thus, by providing for instantaneous sharing of recorded broadcast content, the methods and apparatus may obviate the need to first communicate the files to a PC or other computing device before sharing the media file with another wireless device.

In particular, devices, methods, apparatus, computer-readable media and processors are presented that provide for a user to program a wireless device to capture and record broadcast media content at a predetermined time. In addition to capturing the media content at a predetermined time, the media content is encoded in a compressed format to limit the storage capacity of the media content and, in some instances provide for media content security. Storage of the captured and encoded media content may occur at the wireless device or remotely at a wirelessly networked server device.

In addition to recording media content, in some aspects, the recorded broadcast media content may be designated for sharing amongst other wireless communication devices. In such aspects, the recorded broadcast content may be designated for sharing prior to broadcast, prior to capturing/recording or after the media content has been recorded. Sharing of the media content may require encoding the media file in a speech-format prior to wireless communication. The speech-grade format is an acceptable format for peer-to-peer communication, such as Multimedia-Peer (M2-Peer) communication or the like and, additionally, provides for the transfer of media files in a degraded, lower-quality audio format that is generally viewed as an acceptable means of transferring media flies without infringing on copyright protection. In some aspects, sharing of recorded broadcast files may also include segmenting the media files prior to communicating to the shared device and subsequent concatenation of the segments at the shared device. Segmentation is generally necessary if the communication network, such as a peer-to-peer network, is limited in terms of the file size that may be communicated.

Additionally, in certain aspects the capturing of broadcast media content may include searching the captured content for specific media content prior to encoding and storing the content. For example, in addition to predefining a specific time for initiating the capturing of media content, a user may predefine criteria related to desired media content that is wishes to record. For example, the predefined criteria may include a specific broadcast program, event and/or a specific song, artist or media genre that may occur after the predefined time has elapsed. In such aspects, the captured media content will be searched for the predefined criteria and decisions on encoding and storing the media content will be based on the search results.

In one aspect a method for recording broadcast media content, such as AM or FM radio broadcast, television broadcast or the like, at a wireless device is defined. The method includes receiving a predetermined time for capturing broadcast media content and capturing broadcast media content at the predetermined time. The captured broadcast media content includes a first format that requires a first memory size. The method additionally includes encoding at least a portion of the captured broadcast media content in a second format and storing the encoded broadcast media content, either at the wireless communication device or at a wireless network server. The second format requires a second memory size and the second memory size is less than the first memory size for an equal portion of broadcast media content.

In certain aspects the method may additionally include receiving a content reference to a predetermined one of a plurality of broadcast media content. In such aspects encoding further entails searching header information associated with the captured broadcast media content for one or more record attributes and encoding one or more of the plurality of broadcast media content having a record attribute matching at least a portion of the content reference. In this regard a user is able to provide, in advance, search criteria, such as program title, song title, artist and the like and the wireless device is able to search for the criteria amongst the captured media content header information in order to make decisions on encoding and storing specific portions of the media content.

In other certain aspects the method may additionally include decoding the stored broadcast media content from the second format to a third format requiring a third memory size, encoding, in a speech format, the decoded, broadcast media content and communicating the speech-formatted broadcast media content to a another wireless communication device. The third memory size is greater than the second memory size for an equal portion of broadcast media content. Encoding in a speech-format provides for the broadcast media content to be shared with other wireless communication via multimedia peer (M2-Peer) network or the like. The other wireless communication device may be predetermined prior to capturing the broadcast media content or the other wireless communication may be determined after the broadcast media content has been recorded at the wireless communication device.

Another related aspect is defined by at least one processor configured to perform the actions of receiving a predetermined time for capturing broadcast media content and capturing broadcast media content at the predetermined time. The captured broadcast media content includes a first format that requires a first memory size. The at least one processor is additionally configured to perform the actions of encoding at least a portion of the captured broadcast media content in a second format and storing the encoded broadcast media content. The second format requires a second memory size that is less than the first memory size for an equal portion of broadcast media content.

Yet another related aspect is defined by a machine-readable medium that includes instructions stored thereon. The instructions include a first set of instructions for receiving a predetermined time for capturing broadcast media content and a second set of instructions for capturing broadcast media content at the predetermined time. The captured broadcast media content includes a first format that requires a first memory size. The instructions further include a third set of instructions for encoding at least a portion of the captured broadcast media content in a second format and a fourth set of instructions for storing the encoded broadcast media content. The second format requires a second memory size that is less than the first memory size for an equal portion of broadcast media content.

According to a further aspect, a wireless communication device is defined that includes a computer platform including at least one processor and a memory, a broadcast receiver stored in the memory, executable by the processor and capable of receiving broadcast media content and a broadcast recorder module stored in the memory, executable by the processor and operable for capturing and storing broadcasted media content. The wireless communication device additionally includes a clock function stored in the memory, executable by the processor and operable for launching the broadcast recorder module at a predetermined time to capture broadcasted media content and a media compression codec stored in the memory, executable by the processor and operable for compressing the captured broadcasted media content from a first format that requires a first memory size to a second format that requires a second memory size. The second memory size is less that the first memory size for an equal portion of the broadcast media content.

In certain aspects, the broadcast recorder module of the wireless communication device may additionally include a search engine operable for searching header information associated with the broadcasted media content to identify a predetermined record attribute. In this regard, the broadcast recorder module may further be operable for encoding broadcast media content if the media content includes the predetermined record attribute.

In other aspects, the wireless communication device may include a speech vocoder operable for encoding the stored broadcasted media content in a speech format and a multimedia peer (M2-Peer) communication module operable for communicating the speech-formatted media content to another wireless communication device. The broadcast recorder module may further be operable to determine the other wireless communication device prior to capturing the broadcast media content.

Yet another related aspect is defined by a wireless communication device that includes a means for receiving a predetermined time for capturing broadcast media content and a means for capturing broadcast media content at the predetermined time. The captured broadcast media content includes a first format that requires a first memory size. The wireless communication device additionally includes a means for encoding at least a portion of the captured broadcast media content in a second format and a means for storing the encoded broadcast media content. The second format requires a second memory size that is less than the first memory size for an equal portion of broadcast media content.

A further aspect is defined by a method for receiving shared broadcasted media content at a wireless communication device. The method includes receiving a communication at a wireless communication device that includes at least a segment of a media file comprising speech-formatted broadcast media content, identifying the communication as including at least a segment of the media file and decoding the at least a segment of the media file from a first format to a second format that includes speech-grade audio signals. In some aspects, receiving further includes receiving a Multimedia Peer (M2-Peer) communication at a wireless communication device. Additionally, in some aspects, receiving further includes receiving two or more communications, wherein each communication includes a segment of the media file and the method further includes concatenating the decoded segments of the media file to form a composite media file.

A related aspect is defined by at least one processor. The processor is configured to perform the actions of receiving, at a wireless communication device, a communication that includes at least a segment of a speech-formatted media file, identifying the communication as including at least a segment of the media file and decoding the at least a segment of the media file from a first format to a second format that includes speech-grade audio signals.

A further related aspect is defined by a machine-readable medium that includes instructions stored thereon. The instructions include a first set of instructions for receiving, at a wireless communication device, a communication that includes at least a segment of a speech-formatted media file, a second set of instructions for identifying the communication as including at least a segment of the media file and a third set of instructions for decoding the media file from a first format to a second format that includes speech-grade audio signals.

A wireless communication device defines another aspect. The device includes a computer platform including at least one processor and a memory, a communication module stored in the memory, executable by the processor and operable for receiving a communication and identifying the communication as including at least a segment of a speech-formatted broadcasted media file and a speech vocoder stored in the memory, executable by the processor and operable for decoding the media file from a first format to a second format that includes speech-grade audio signals.

A further related aspect is defined by a wireless communication device that includes a means for receiving a communication that includes at least a segment of a speech-formatted, broadcast media file, a means for identifying the communication as including at least a segment of the media file and a means for decoding the media file from a first format to a second format that includes speech-grade audio signals.

Thus, present aspects provide for methods, apparatus, computer program products, processors and the like that record broadcast media content at a wireless communication device and, in some aspects, share the recorded broadcast media content with other wireless communication devices. The disclosed aspects capture broadcasted media content, such as radio or television broadcasted content at predetermined times. In this regard, a clock function resident on the wireless communication device launches the capture and record module at the predetermined time. The captured media content is then encoded in a compressed format readily conducive to the memory limitations typical of a wireless communication device. In certain aspects, the device incorporates a search function that allows for the predetermined selection of media content criteria that is used to search and determine the media content that is encoded and stored for subsequent use and/or sharing. In other aspects, the recorded broadcast media content is shared with other wireless communication devices by encoding the recorded/stored media content in a speech-format and communicating the speech-formatted media content to other wireless devices, typically via a multimedia peer (M2-Peer) network.

### BRIEF DESCRIPTION OF THE DRAWINGS

The disclosed aspects will hereinafter be described in conjunction with the appended drawings, provided to illustrate and not to limit the disclosed aspects, wherein like designations denote the elements, and in which:

FIG. 1 is a block diagram of a system for sharing broadcast media content amongst wireless communication devices, in accordance with an aspect;

FIG. 2 is block diagram of a wireless device for receiving, recording and sharing broadcast media content, in accordance with an aspect;

FIG. 3 is a block diagram of a wireless device for receiving shared broadcast media content, in accordance with another aspect;

FIG. 4 is a block diagram of a broadcast communication network that includes a transport system that operates to create and transport multimedia content flows across data networks, in accordance with an aspect;

FIG. 5 is a block diagram of a method for recording broadcast media content on a wireless communication device, in accordance with an aspect;

FIG. 6 is a block diagram of a method for recording broadcast media content on a wireless communication device and sharing the recorded media content with another wireless communication device, in accordance with an aspect;

FIG. 7 is a block diagram of a method for block diagram of a method for recording broadcast media content on a wireless communication device and sharing the recorded media content with another wireless communication device, in which the recorded media content is segmented prior to sharing and concatenated after sharing, in accordance with an aspect;

FIG. 8 is a flow diagram of a method for recording broadcast media content on a wireless communication device, in accordance with an aspect;

FIG. 9 is a flow diagram of a method for searching for predefined record criteria and recording, search-matched, broadcast media content on a wireless communication device, in accordance with an aspect;

FIG. 10 is a flow diagram of a method for recording broadcast media content on a wireless communication device and sharing the recorded media content with another wireless communication device, in accordance with an aspect; and

FIG. 11 is a flow diagram of a method for receiving shared broadcast media content at a wireless communication device, in accordance with an aspect.

### DETAILED DESCRIPTION

The present devices, apparatus, methods, computer-readable media and processors now will be described more fully hereinafter with reference to the accompanying drawings, in which aspects of the invention are shown. The devices, apparatus, methods, computer-readable media and processors, however, may be embodied in many different forms and should not be construed as limited to the aspects set forth herein; rather, these aspects are provided so that this disclosure will be thorough and complete, and will fully convey the scope of the invention to those skilled in the art. Like numbers refer to like elements throughout.

The various aspects are described herein in connection with a wireless communication device. A wireless communication device can also be called a subscriber station, a subscriber unit, mobile station, mobile, remote station, access point, remote terminal, access terminal, user terminal, user agent, a user device, or user equipment. A wireless communication device may be a cellular telephone, a cordless telephone, a two-way radio (e.g., walkie-talkie), a Session Initiation Protocol (SIP) phone, a wireless local loop (WLL) station, a personal digital, assistant (PDA), a wireless Walkman™, a handheld device having wireless connection capability, or other processing device connected to a wireless modem.

The described aspects provide for methods, apparatus and systems for recording broadcast media content on a wireless device and, in some aspects sharing the recorded media content with other wireless communication devices. The disclosed aspects capture broadcasted media content, such as radio or television broadcasted content or the like, at predetermined times. In this regard, a user predetermines a start time and a clock function resident on the wireless communication device launches a capture and record function at the predetermined time. The captured media content is then encoded in a compressed format and stored, either locally at the wireless communication device or remotely at a wireless network device. In certain aspects, the device incorporates a search function that allows for the predetermined selection of media content criteria that is used to search and determine the media content that is encoded and stored for subsequent use and/or sharing. In other aspects, the recorded broadcast media content is shared with other wireless communication devices by encoding the recorded/stored media content in a speech-format and communicating the speech-formatted media content to other wireless devices, typically via a multimedia peer (M2-Peer) network.

The communication of media files between wireless communication devices using Multi-Media Peer (M2-Peer) communication is described in detail in U.S. patent application Ser. No. 11/202,805, entitled “Methods and Apparatus for Providing Peer-to-Peer Data Networking for Wireless Devices,” filed on Aug. 12, 2005, in the name of inventors Duggal et al, and assigned to the same inventive entity as the present application. The '805 Duggal application describes methods and apparatus for providing server-less peer-to-peer communication amongst wireless communication devices. The '805 Duggal application is hereby incorporated by reference as if setforth fully herein. The M2-Peer communication network is a network that utilizes the computing power and bandwidth of the participants in the network rather that concentrating power and bandwidth in a relatively in network servers. A M2-Peer network does not have the notion of clients or servers, but only equal peer nodes that simultaneously function as both “clients” and “servers” to the other nodes on the network. This model of network arrangement differs from the client-server model where communication is usually to and from a central server. In a M2-Peer communication network there is no central server acting as a router to manage the network.

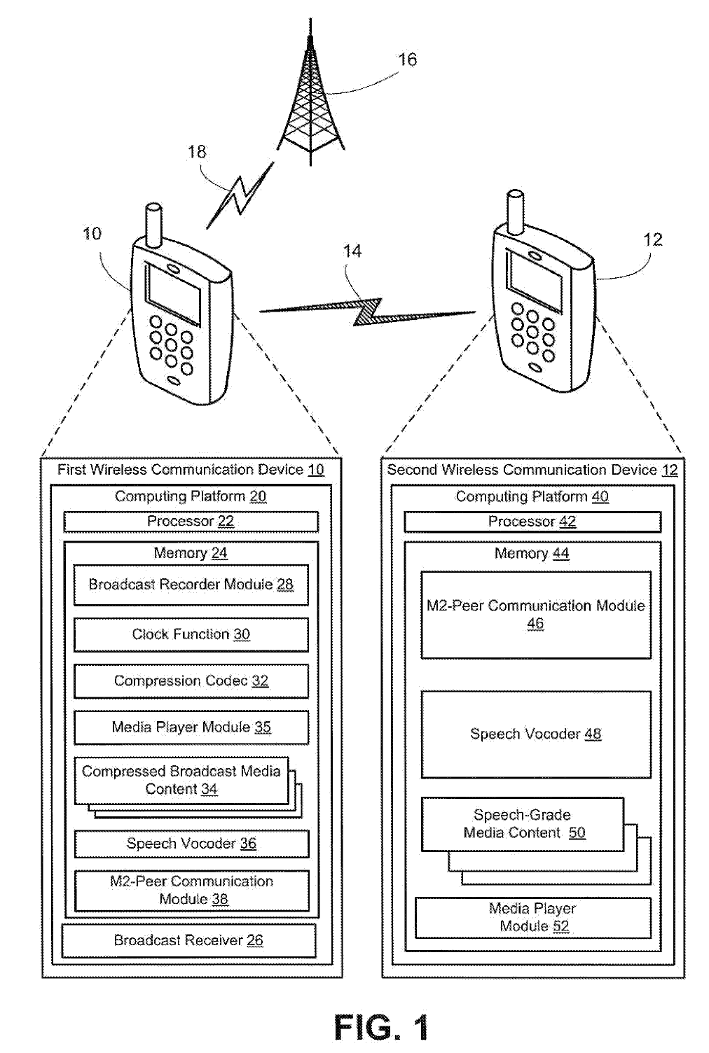

Referring to FIG. 1, a schematic representation of a system for recording and sharing broadcast media content is depicted. The system includes a first wireless communication devices 10, also referred to herein as the recording and/or sharing device, and a second wireless communication device 12, also referred to herein as the media content receiving device. The first and second wireless communication devices may be in wireless communication via a peer-to-peer network, such as M2-Peer communication network 14. The M2-Peer communication network 14 provides for one communication mechanism for sharing the broadcast media contest. Other communication networks may also be used to share the broadcast media content and should be considered with the bounds of the present aspects. It should be noted that while the first wireless communication device 10 is described as the media content recording and sharing device and the second wireless communication device is described as the media file receiving device, in most instances the wireless communication devices will be configured to be capable of recording, sharing and receiving broadcast media content. It is only for the sake of clarity that the wireless communication devices are described herein as being a broadcast media content recording and sharing device or a broadcast media content receiving device. Thus, the wireless devices described and claimed herein should not be viewed as limited to a device that records and shares broadcast media content or a device that receives shared broadcast media content but should include wireless communication devices that are capable of any combination of options herein proposed.

The first wireless communication device 10 is equipped to receive broadcast media content via broadcast network 16 that comprises a plurality of broadcast towers 18. The broadcast network may be a conventional radio broadcast network capable of transmitting AM or FM radio signals, a television broadcast network capable of transmitting television signals, a multicast network such as a Forward Link Only (FLO) network, such as the MediaFlo™ system available from Qualcomm, Inc. of San Diego, Calif.; a digital video broadcasting (DVB) network, such as DVB-S for satellite, DVB-C for cable, DVB-T for terrestrial television, DVB-H for terrestrial television for handhelds, satellite digital multimedia broadcasting (S-DMB), terrestrial DMB (T-DMB), digital radio mondiale (DRM), digital audio broadcasting (DAB), Multimedia Broadcast Multicast Service (MBMS) and the like.

The first wireless communication device 10, also referred to herein as the media file communicating device, includes a computing platform 20 that includes at least one processor 22 and a memory 24. The computing platform 20 also includes a broadcast receiver 26 that is operable for receiving broadcast signals communicated via broadcast network 18. In aspects in which the first wireless communication device is configured to receive broadcast signals from various different broadcast networks, such as radio broadcasts and television broadcasts, the device may include multiple different broadcast receivers.

The memory 24 also includes a broadcast recorder module 28 that is operable for capturing broadcast media content and subsequently compression encoding at least a portion of the captured media content for storage purposes. The broadcast recorder module is in communication with clock function 30 that is operable to allow a device user to select a time to awaken or launch the broadcast recorder module 28. Typically a user may predetermine a start time (e.g., an awaken or launch time) and a stop time (e.g., a sleep or shutdown time), which defines a time period for capturing broadcast media content. The broadcast recorder module 28 is operable for capturing broadcasted media content at a predetermined time or for the predetermined time period as dictated by the clock function 30. In this regard, a device user can pre-program the device to capture and record an upcoming, scheduled broadcast. For example, if the user is aware that a predetermined radio station will broadcast a predetermined event at a specific time period, the user may pre-configure the broadcast recorder module to capture, encode and store media content broadcasted by the station during the predetermined time period. Alternatively, the broadcast recorder module 28 may be launched instantaneously by a device user on an as-needed basis. For example, a user listening to a radio broadcast may desire to record the broadcast, in which case, the user may interface with the wireless device to pull up the broadcast recorder function and opt to immediately beginning capturing, encoding and storing the broadcast media content. In this example, the user may choose to define a stop time, which is controlled by the clock function 30.

In alternate aspects, the broadcast receiver 26 is in communication with the clock function 30 that is operable to allow a device user to select a time to awaken or launch the broadcast receiver 26. Typically a user may predetermine a start time (e.g., an awaken or launch time) and a stop time (e.g., a sleep or shutdown time), which defines a time period for capturing broadcast media content. Awakening of the broadcast receiver 26 may prompt the broadcast recorder module 28 to record all broadcasted media content at the start time or during the record period or record the content that meets any predefined search criteria.

The broadcast recorder module 28 also includes compression codec 32 operable encoding and/or decoding the broadcast media content to and from a compressed format. In operation, the broadcast media content signals are received in a first format, such as an un-compressed format. The decompressed format is generally not acceptable in terms of storage because the decompressed format requires large amounts of storage space, which is generally a limited resource for a wireless communication device. The compression codec 32 converts the received first format that requires a first memory size to a second format, which requires a second memory size that is less than the first memory size for an equal portion of broadcast media content. Examples of suitable compression codecs include, but are not limited to, MPEG (Motion Pictures Expert Group) Audio Layer III, commonly referred to as MP3, Advanced Audio Code (AAC), AAC+, eAAC+, HE-AAC (High Efficiency AAC), ITU-T (International Telecommunications Union-Telecommunications), G.711 ITU-T G.722, ITU-T G.722.1, ITU-T G.722.2, ITU-T G.723, ITU-T G.723.1, ITU-T G.726, ITU-T G.729, ITU-T G.729a, FLAC (Free Lossless Audio Codec), Ogg, Theora, Vorbis, ATRAC3 (Adaptive, TRansform, Acoustic Coding-3), AC3, AIFF-C (Audio Interchange File Format 3) or the like. In addition, compression codec 32 is operable for decoding the compressed format prior to consuming/playing the media content on the wireless device or prior to processing the media content for sharing with another wireless communication device.

Once the captured broadcast media content has been compression encoded, the media content may be stored (e.g., recorded) locally at the wireless device as compressed broadcast media files 34. In alternate aspects, the compressed broadcast media files 34 may be stored remotely at a network device and communicated to the wireless device when the user desires to consume/play the media content or when the user desires to share the media content. Remote storage of the compressed broadcast media content may be required if first wireless communication device 10 has memory/storage limitations.

In those aspects which provide for the recorded broadcast media content to be shared with other wireless communication devices the memory 24 may also include a speech vocoder 36 operable for encoding and/or decoding the broadcast media content to and from a speech-format. Speech formatting of the broadcast media content may be required prior to sharing (e.g., communicating) the broadcast media content with other wireless communication devices. Speech formatting allows for media content to be communicated via peer-to-peer communication networks, such as M2-Peer communication networks and the like. Additionally, speech-formatting provides for degrading the speech signal of the media content to allow for acceptable sharing of the media content in view of intellectual property rights that may be associated with the media content. In operation, the compressed media content is decoded, by implementing compression codec 32 and temporarily stored prior to encoding the media content in a speech-format, by implementing speech vocoder 36. The speech-grade audio format will characteristically have a limited bandwidth in the range of about 20 hertz (Hz) to about 20 kilohertz (kHz). By comparison, conventional multimedia content files may have audio formatted in the bandwidth range of about 5 Hz to about 50 kHz. Examples of speech-codecs include, but are not limited to Qualcomm Code Excited Linear Predictive (QCELP), Enhanced Variable Rate Codec (EVRC), Internet Low Bitrate Codec (iLBC), Speex and the like.

Additionally, in those aspects which provide for the recorded broadcast media content to be shared with other wireless communication devices the memory 24 may also include a peer-to-peer communication module, such as Multimedia Peer (M2-Peer) communication module 38 operable for communicating the speech-formatted media content to one or more designated wireless communication devices. As previously noted, the M2-Peer communication module 38 may also be operable for receiving speech-formatted broadcast media content being shared by other wireless communication devices. As such, the M2-Peer communication module 38 included in the first wireless communication device 10 may include any and all of the components, logic and functionality exhibited by the M2-Peer communication module 46 discussed in relation to the second wireless communication device 12.

The second wireless communication device 12, also referred to herein as the broadcast media content receiving or recipient device, includes a computing platform 40 at least one processor 42 and a memory 44. The memory 44 includes a peer-to-peer communications module, such as M2-Peer communication module 46. The M2-Peer communication module is operable for receiving and communicating M2-Peer communications, including communications including speech-formatted broadcast media content. As such, the M2-Peer communication module 46 included in the second wireless communication device 12 may include any and all of the components, logic and functionality exhibited by the M2-Peer communication module 38 discussed in relation to the first wireless communication device 10.

The M2-Peer communication module 44 additionally is operable for reading and interpreting the information included in the M2-Peer communication headers. The header information will typically identify an M2-Peer communication as including speech-formatted media content and the associated speech format used to encode the segment. By identifying the communication as including media content, the M2-Peer communication module recognizes that the file needs to be communicated to a media player module for subsequent consumption/playing.

The memory 44 may include speech vocoder 46 operable for decoding the speech-formatted broadcast media content. The speech vocoder 46 may be configured to provide decoding of one or more speech-format codes and, at a minimum, decoding of the speech format used by the communicating/sharing wireless communication device 10. The decoding of the audio portion of the media content results in speech-grade media content 50 that may be consumed/played on the wireless device without permanent storage, stored locally in the device memory 44 or stored remotely at a wireless network device.

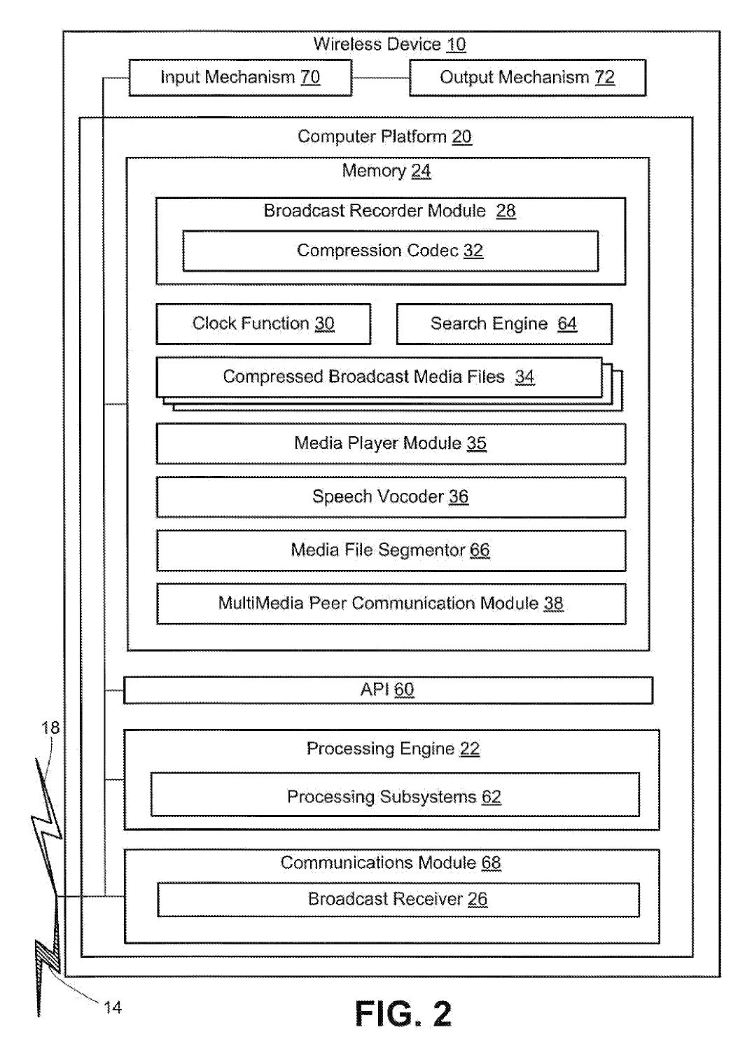

Referring to FIG. 2, according to one aspect, a block diagram representation of a first wireless communication device 10, otherwise referred to as the broadcast recording or sharing wireless device, operable for recording broadcast media content and, in some aspects, sharing the recorded broadcast media content with oilier wireless communication devices. The wireless communication device 10 may include any type of computerized, communication device, such as cellular telephone, Personal Digital Assistant (PDA), two-way text pager, portable computer, and even a separate computer platform that has a wireless communications portal, and which also may have a wired connection to a network or the Internet. The wireless communication device can be a remote-slave, or other device that does not have an end-user thereof but simply communicates data across the wireless network, such as remote sensors, diagnostic tools, data relays, and the like. The present apparatus and methods can accordingly be performed on any form of wireless communication device or wireless computer module, including a wireless communication portal, including without limitation, wireless modems, PCMCIA, cards, access terminals, desktop computers or any combination or sub-combination thereof.

The wireless communication device 10 includes computer platform 20 that can transmit data across a wireless network, and that can receive and execute routines and applications. Computer platform 20 includes memory 24, which may comprise volatile and nonvolatile memory such as read-only and/or random-access memory (RAM and ROM), EPROM, EEPROM, flash cards, or any memory common to computer platforms. Further, memory 24 may include one or more flash memory cells, or may be any secondary or tertiary storage device, such as magnetic media, optical media, tape, or soft or hard disk.

Further, computer platform 20 also includes a processing engine 22, which may be an application-specific integrated circuit (“ASIC”), or other chipset, processor, logic circuit, or other data processing device. Processing engine 22 or other processor such as ASIC may execute an application programming interface (“API”) layer 60 that interfaces with any resident programs, such as broadcast recorder module 28 and/or M2-peer communication module 38, stored in the memory 24 of the wireless device 10. API 60 is typically a runtime environment executing on the respective wireless device. One such runtime environment is Binary Runtime Environment for Wireless® (BREW®). software platform developed by Qualcomm, Inc., of San Diego, Calif. Other runtime environments may be utilized that, for example, operate to control the execution of applications on wireless computing devices.

Processing engine 22 includes various processing subsystems 62 embodied in hardware, firmware, software, and combinations thereof, that enable the functionality of communication device 10 and the operability of the communication device on a wireless network. For example, processing subsystems 62 allow for initiating and maintaining communications, and exchanging data, with other networked devices. In aspects in which the communication device is defined as a cellular telephone the communications processing engine 22 may additionally include one or a combination of processing subsystems 62, such as: sound, non-volatile memory, file system, transmit, receive, searcher, layer 1, layer 2, layer 3, main control, remote procedure, handset, power management, digital signal processor, messaging, call manager, Bluetooth® system, Bluetooth® LPOS, position engine, user interface, sleep, data services, security, authentication, USIM/SIM, voice services, graphics, USB, multimedia such as MPEG, GPRS, etc (all of which are not individually depicted in FIG. 2 for the sake of clarity). For the disclosed aspects, processing subsystems 62 of processing engine 22 may include any subsystem components that interact with the broadcast recorder module 28 and/or the M2-Peer communication module 38 on computer platform 20.

The computer platform 20 includes a broadcast receiver 26 that is operable for receiving broadcast signals communicated via broadcast network 18. In aspects in which the first wireless communication device is configured to receive broadcast signals from various different broadcast networks, such as radio broadcasts and television broadcasts, the device may include multiple different broadcast receivers, such as an AM radio receiver, a FM radio receiver, a television receiver, a unicast receiver, a multicast receiver or the like.

The memory 24 also includes a broadcast recorder module 28 that is operable for capturing broadcast media content and subsequently compression encoding at least a portion of the captured media content for storage purposes. The broadcast recorder module is in communication with clock function 30 that is operable to allow a device user to select a time to awaken or launch the broadcast recorder module 28. Typically a user may predetermine a start time (e.g., an awaken or launch time) and a stop time (e.g., a sleep or shutdown time), which defines a time period for capturing broadcast media content. The broadcast recorder module 28 is operable for capturing broadcasted media content at a predetermined time or for a predetermined time period as dictated by the clock function 30. Alternatively, the broadcast recorder module 28 may be launched by a device user on an as-needed basis. In the instance in which the user launches the broadcast recorder module on an as-needed basis, the user may choose to define a stop time, which is controlled by the clock function 30. In alternate aspects, the broadcast receiver 26 may be in communication with clock function 30, such that the clock function is operable to allow a device user to select a time to awaken or launch the broadcast receiver 26.

The memory may also include a search engine 64 that is in communication with the broadcast recorder module 28 and is operable for searching the captured media content for one or more broadcast media content attributes associated with the content. The record attributes may include, but are not limited to, a broadcast program title, an artist name, a song or album title or the like. A record attribute may be predefined by a device user prior to capturing the broadcast media content. In specific aspect, a user may predefine one or more record attributes when predefining the time or time period for capturing the broadcast content. Alternatively, a user may predefine one or more record attributes when launching the broadcast recorder module 28 on an as-needed basis. The search engine 64 will search the metadata associated with the captured broadcast media content to find one or more portions of the media content that have one or more of the predefined record attributes. In aspects in which the search engine 64 is implemented the captured media content is searched and if a match between one or more of the predefined record attributes is found, the portion of the media content having the record attribute is compression encoded and stored (e.g., recorded). For example, if a user chooses a specific song title as a record attribute, the search engine will search the captured media content for the song title and if and when a match is found the media content that includes the searched song is compression encoded and stored.

The broadcast recorder module 28 also may include a compression codec 32 operable for encoding and/or decoding the broadcast media content to and from a compressed format. In operation, the broadcast media content signals are received in a first format, such as an un-compressed format. The decompressed format is generally not conducive to storage on a wireless device because the wireless communication device is generally limited in terms of storage/memory capacity. The compression codec 32 converts the received first format, which requires a first memory size, to a second format, which requires a second memory size that is less than the first memory size for an equal portion of broadcast media content. Examples of suitable compression codecs include, but are not limited to, MPEG (Motion Pictures Expert Group) Audio Layer III, commonly referred to as MP3, Advanced Audio Code (AAC), AAC+, eAAC+, HE-AAC, ITU-T G.711, ITU-T G.722, ITU-T G.722.1, ITU-T G.722.2, ITU-T G.723, ITU-T G.723.1, ITU-T G.726, ITU-T G.729, ITU-T G.729a, FLAC, Ogg, Theora, Vorbis, ATRAC3, AC3, AIFF-C or the like. In addition, compression codec 32 is operable for decoding the compressed format prior to consuming/playing the media content on the wireless device or prior to processing the media content for sharing with another wireless communication device. It should be noted that while the compression codec 32 is depicted as being included in the broadcast recorder module 28 it may reside outside of the broadcast recorder module, anywhere in memory 24 and be in communication with broadcast recorder module 28.

Once the captured broadcast media content has been compression encoded, the media content may be stored (e.g., recorded) locally at the wireless device as compressed broadcast media files 34 that are accessible for consumption/playing by media player module 35. In alternate aspects, the compressed broadcast media files 34 may be stored remotely at a network device and communicated to the wireless device when the user desires to consume/play the media content on media player module 35 or when the user desires to share the media content. Remote storage of the compressed broadcast media content may be required if first wireless communication device 10 has memory/storage limitations.

In those aspects which provide for the recorded broadcast media content to be shared with other wireless communication devices the memory 24 may also include a speech vocoder 36 operable for encoding and/or decoding the broadcast media content to and from a speech-format. Speech formatting of the broadcast media content may be required prior to sharing (e.g., communicating) the broadcast media content with other wireless communication devices. Speech formatting allows for media content to be communicated via peer-to-peer communication networks, such as M2-Peer communication networks and the like. Additionally, speech-formatting provides for degrading the speech signal of the media content to allow for acceptable sharing of the media content in view of intellectual property rights that may be associated with the media content. In operation, the compressed media content is decoded, by implementing compression codec 32 and temporarily stored prior to encoding the media content in a speech-format, by implementing speech vocoder 36. The speech-grade audio format will characteristically have a limited bandwidth in the range of about 20 hertz (Hz) to about 20 kilohertz (kHz). By comparison, conventional multimedia content files may have audio formatted in the bandwidth range of about 5 Hz to about 50 Hz. Examples of speech-codecs include, but are not limited to, Qualcomm Code Excited Linear Predictive (QCELP), Enhanced Variable Rate Codec (EVRC), Internet Low Bitrate Codec (iLBC), Speex and the like.

Additionally, In those aspects which provide for the recorded broadcast media content to be shared with other wireless communication devices the memory 24 may also include a media file segmentor 66 operable for segmenting the media file into two or more segments, otherwise referred to as media clips. Certain communication networks may be limited by the size/length of the media file that can be communicated. For example, a peer-to-peer network, such as an M2-Peer network may be limited to communication of audio media clips having a maximum length of about 60 seconds to about 90 seconds. In instances in which the communication network is limited in terms of the length of the media file, the segmentor allows for the media file to be segmented prior to communication and for the segments to be concatenated at the receiving wireless device 12 to form the composite media file.

Additionally, In those aspects which provide for the recorded broadcast media content to be shared with other wireless communication devices the memory 24 may also include a peer-to-peer communication module, such as Multimedia Peer (M2-Peer) communication module 38 operable for communicating the speech-formatted media content to one or more designated wireless communication devices. As previously noted, the M2-Peer communication module 38 may also be operable for receiving speech-formatted broadcast media content being shared by other wireless communication devices. As such, the M2-Peer communication module 38 included in the first wireless communication device 10 may include any and all of the components, logic and functionality exhibited by the M2-Peer communication module 46 discussed in relation to the second wireless communication device 12.

Computer platform 60 may further include communications module 68 embodied in hardware, firmware, software, and combinations thereof, that enables communications among the various components of the wireless communication device 10, as well as between the communication device 10 and broadcast network 16 and M2-Peer network 14. In described aspects, the communication module enables the communication of all correspondence between the first wireless communication device 10, the second wireless communication device 12 and the broadcast towers 18. The communication module 68 may include the requisite hardware, firmware, software and/or combinations thereof for establishing a wireless or wired network communication connection.

Additionally, communication device 10 has input mechanism 70 for generating inputs into communication device, and output mechanism 72 for generating information for consumption by the user of the communication device. For example, input mechanism 76 may include a mechanism such as a key or keyboard, a mouse, a touch-screen display, a microphone, etc. In certain aspects, the input mechanisms 70 provides for user input to activate and interface with an application, such as the media player application or the like on the communication device. Further, for example, output mechanism 72 may include a display, an audio speaker, a haptic feedback mechanism, etc. In the illustrated aspects, the output mechanism may include a display and an audio speaker operable to display video content and audio content; respectively, associated with a media content file.

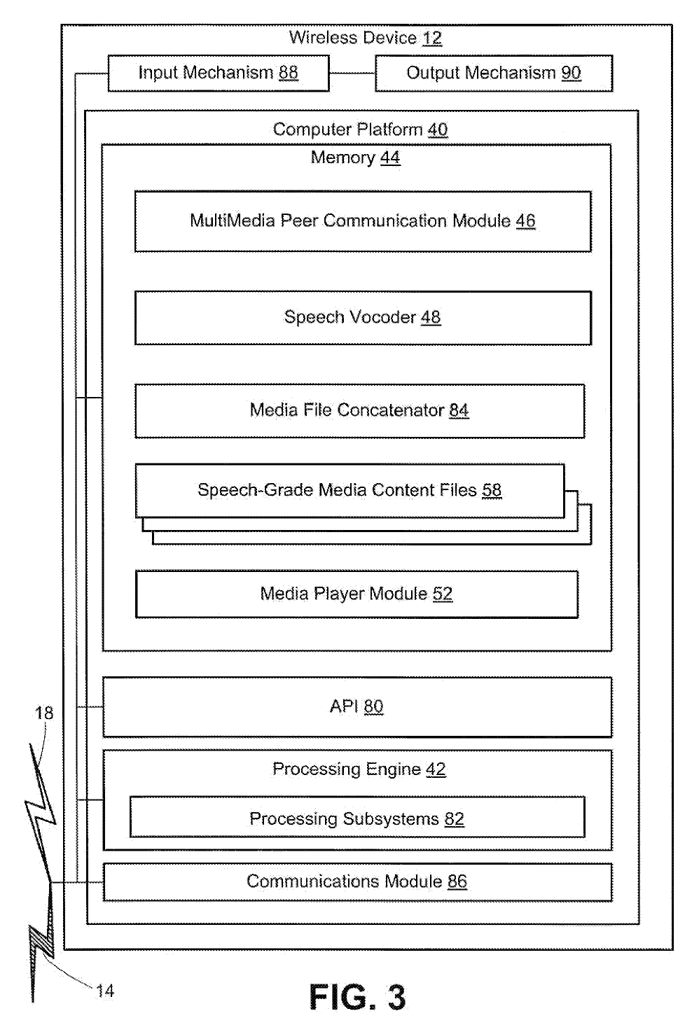

Referring to FIG. 3, according to one aspect, a block diagram representation of a second wireless communication device 12, otherwise referred to as the media content receiving or recipient wireless device, operable for receiving shared speech-grade broadcast media content files communicated from the first wireless communication device 10. The wireless communication device 12 may include any type of computerized, communication device, such as cellular telephone, Personal Digital Assistant (PDA), two-way text pager, portable computer, and even a separate computer platform that has a wireless communications portal, and which also may have a wired connection to a network or the Internet. The wireless communication device can be a remote-slave, or other device that does not have an end-user thereof but simply communicates data across the wireless network, such as remote sensors, diagnostic tools, data relays, and the like. The present apparatus and methods can accordingly be performed on any form of wireless communication device or wireless computer module, including a wireless communication portal, including without limitation, wireless modems, PCMCIA cards, access terminals, desktop computers or any combination or sub-combination thereof.

The wireless communication device 12 includes computer platform 40 that can transmit data across a wireless network, and that can receive and execute routines and applications. Computer platform 40 includes memory 44, which may comprise volatile and nonvolatile memory such as read-only and/or random-access memory (RAM and ROM), EPROM, EEPROM, flash cards, or any memory common to computer platforms. Further, memory 44 may include one or more flash memory cells, or may be any secondary or tertiary storage device, such as magnetic media, optical media, tape, or soft or hard disk.

Further, computer platform 40 also includes a processing engine 42, which may be an application-specific integrated circuit (“ASIC”), or other chipset, processor, logic circuit, or other data processing device. Processing engine 42 or other processor such as ASIC may execute an application programming interface (“API”) layer 80 that interfaces with any resident programs, such as media player module 52 and/or M2-peer communication module 44, stored in the memory 42 of the wireless device 12. API 80 is typically a runtime environment executing on the respective wireless device. One such runtime environment is Binary Runtime Environment for Wireless® (BREW®) software platform developed by Qualcomm, Inc., of San Diego, Calif. Other runtime environments may be utilized that, for example, operate to control the execution of applications on wireless computing devices.

Processing engine 40 includes various processing subsystems 82 embodied in hardware, firmware, software, and combinations thereof, that enable the functionality of communication device 12 and the operability of the communication device on a wireless network. For example, processing subsystems 82 allow for initiating and maintaining communications, and exchanging data, with other networked devices. In aspects in which the second wireless communication device 12 is defined as a cellular telephone the communications processing engine 42 may additionally include one or a combination of processing subsystems 82, such as: sound, non-volatile memory, file system, transmit, receive, searcher, layer 1, layer 2, layer 3, main control, remote procedure, handset, power management, digital signal processor, messaging, call manager, Bluetooth® system, Bluetooth® LPOS, position engine, user interface, sleep, data services, security, authentication, USIM/SIM, voice services, graphics, USB, multimedia such as MPEG, GPRS, etc (all of which are not individually depicted in FIG. 3 for the sake of clarity). For the disclosed aspects, processing subsystems 82 of processing engine 42 may include any subsystem components that interact with the media player module 52 and/or the M2-Peer communication module 46 on computer platform 40.

The memory 44 of computer platform 40 includes an M2-Peer communication module 46. The M2-Peer communication module is operable for receiving and communicating M2-Peer communications, including communications that include speech-formatted broadcast media content communicated from first wireless communication device 10. As such, the M2-Peer communication module 46 included in the second wireless communication device 12 may include any and all of the components, logic and functionality exhibited by the M2-Peer communication module 38 discussed in relation to the first wireless communication device 10.

The M2-Peer communication module 46 additionally is operable for identifying the communication as including speech-formatted media content. In this regard the M2-Peer communication module 46 may be operable for reading and interpreting the information included in the M2-Peer communication headers. The header information may include identification that recognizes the M2-Peer communication as including speech-formatted media file, the speech format used to encode the segment and the like. By identifying the communication as including speech-formatted media content, the M2-Peer communication module recognizes that the file needs to be communicated to a speech vocoder 48 for subsequent decoding and to the media player module 52 for subsequent consumption/playing of the media content.

The memory 44 may include speech vocoder 48 operable for decoding the speech-formatted media content. The speech vocoder 50 may be configured to provide decoding of one or more speech-format codes and, at a minimum, decoding of the speech format used by the communicating/sharing wireless communication device 10. The decoding of the audio segments results in speech-grade media content.

In some aspects in which the media content is segmented prior to communication, the memory 44 may include media concatenator 84. The media concatenator 84 is operable for assembling segmented media files in sequence to form the speech-grade media content files 58.

The memory 44 of second wireless communication device 12 may additionally include a media player module 52 operable for receiving and consuming/playing speech-grade media files. The media player module 52 may additionally be operable for reading header information associated with the media content file, such as information related to the media file, advertising information, in the form of media file service provider links or the like, or any other associated information.

Computer platform 40 may further include communications module 86 embodied in hardware, firmware, software, and combinations thereof, that enables communications among the various components of the wireless communication device 12, as well as between the communication device 12 and broadcast network 16 and M2-Peer network 14. In described aspects, the communication module enables the communication of all correspondence between the first wireless communication device 10, the second wireless communication device 12 and the broadcast towers 18. The communication module 86 may include the requisite hardware, firmware, software and/or combinations thereof for establishing a wireless or wired network communication connection.

Additionally, communication device 12 has input mechanism 88 for generating inputs into communication device, and output mechanism 90 for generating information for consumption by the user of the communication device. For example, input mechanism 88 may include a mechanism such as a key or keyboard, a mouse, a touch-screen display, a microphone, etc. In certain aspects, the input mechanisms 88 provides for user input to activate and interface with an application, such as the media player module 52 on the communication device. Further, for example, output mechanism 90 may include a display, an audio speaker, a haptic feedback mechanism, etc. In the illustrated aspects, the output mechanism may include a display and an audio speaker operable to display video content and audio content; respectively, associated with a media content file.

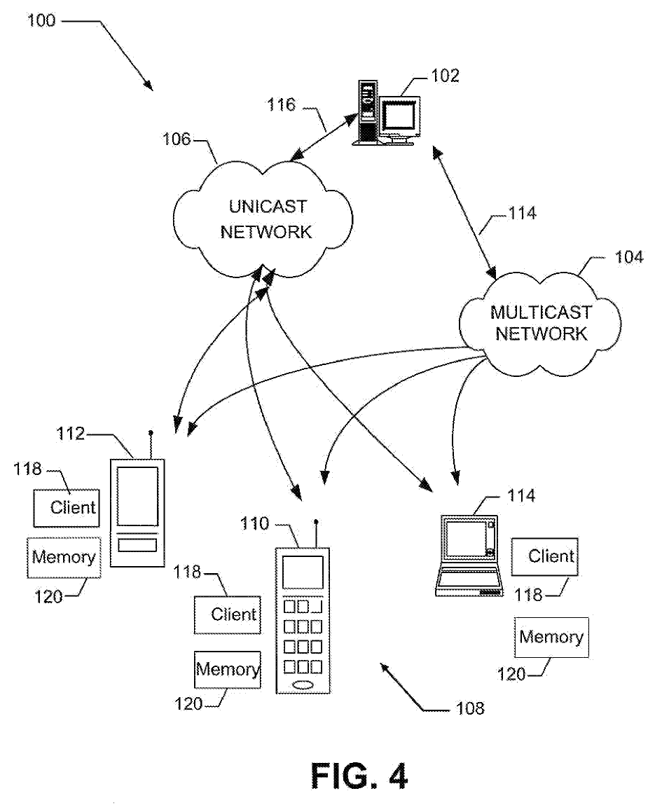

FIG. 4 illustrates a broadcast communication network 100 that includes a transport system that operates to create and transport multimedia content flows across data networks, in accordance with an aspect. For example, the transport system is suitable for use in transporting content clips from a server network to a wireless access network for broadcast distribution. The network 100 includes a network device, such as server 102, a multicast network 104, and a wireless access or unicast network 106. The network 100 also includes devices 108 that include a mobile telephone 110, a personal digital assistance (PDA) 112, and a notebook computer 112. The devices 108 illustrate just some of the devices that are suitable for use in one or more aspects of the transport system and may be configured to provide for broadcast media content recording and, in some aspects sharing of the recorded broadcast media content. It should be noted that although three devices are shown in FIG. 4, virtually any number or type of wireless devices are suitable for use in the present system.

The server 102 operates to provide content for distribution to users in the network 100. The content includes, but is not limited to, video, audio, multimedia content, clips, real-time and non real-time content or any other type of suitable media content. The server 100 provides the content to the multicast network 104 and/or the unicast network 106 for distribution. For example the server 100 communicates with the multicast network 104 via the communication link 114, which comprises any suitable type of wired and/or wireless communication link. Likewise, the server 100 communicates with the unicast network 106 via the communication link 116, which comprises any suitable type of wired and/or wireless communication link

The network 100 includes any combination of wired and wireless networks that operate to distribute content for delivery to users. The multicast network 104 includes any combination of wired and wireless networks that are designed to broadcast high quality content. For example, the multicast network 104 may be a specialized proprietary network that has been optimized to deliver high quality content to selected devices over a plurality of optimized communication channels.

In one or more aspects, the transport system operates to deliver content from the server 102 through the multicast network 106 or the unicast network 104, to the wireless devices 108. For example, content flow may comprise a non real-time content clip that was provided by the server 102 for distribution using the multicast network 106. In one aspect, the server 102 operates to negotiate with the multicast network 106 to determine one or more parameters associated with the content clip. Once the multicast network 106 receives the content clip, it broadcasts/multicasts the content clip over the network 100 for reception by one or more of the devices 108. Any of the devices 108 may be authorized to receive the content clip and record it and/or share it in accordance with present aspects.

For example, the devices 108 include a client program 118 that operates to provide a program guide that displays a listing of content that is scheduled for broadcast over the network 100. The device user may then select to receive any particular content for rendering in real-time or to be recorded and stored in a memory 120 for later viewing. For example the content clip may be scheduled for broadcast during the evening hours, and the device 108 operates to receive the broadcast and record the content in the memory 120 so that the device user may view the clip in the future. Typically, the content is broadcast as part of a subscription service and the receiving device may need to provide a key or otherwise authenticate itself to receive the broadcast.

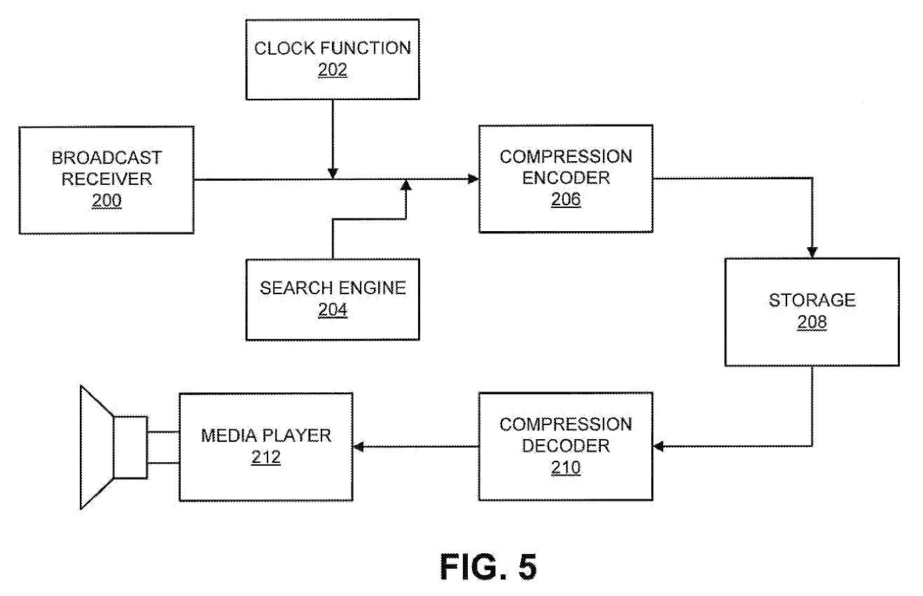

Referring to FIG. 5, a flow diagram of a method for recording broadcast media content on a wireless communication device in an M2-Peer network is depicted. At Event 200, a wireless communication device receives broadcast media content. The broadcast receiver may be configured to receive AM radio signals, such as signals in the frequency range of about 88 megahertz (MHz) to about 108 MHz, FM radio signals, such as signals in the frequency range of about 535 kilohertz (kHz) to about 1605 kHz, television signals, such as signals in the frequency range of about 30 megahertz (MHz) to about 3000 MHz, and any other signals carrying broadcast media content.

At Event 202, capturing of the received broadcast media content is triggered at a predetermined time as designated by a clock function. A device user may provide an input to the wireless device, such as input to a media player application or a broadcast recorder application, which predefines a time for initiating the capture of broadcast media content or predefines a time period for capturing broadcast media content. In addition to predefining the time for capture of broadcast media content the device user may predefine the broadcast channel from which media content is captured. In alternate aspects, in lieu of setting a broadcast media capture time in advance of capturing the media content, the wireless device may provide for the user to activate the capture and record function at any point in time for immediate recording of broadcast media content.

At Event 204, the captured media content may be searched for predetermined record attributes. In some aspects, a device user may predetermine one or more record attributes associated with media content. For example, a user may predetermine a program title, a song title, a scheduled event, an artist or the like in advance of a scheduled capture and record time. In some aspects, the user may predetermine the record attributes concurrently with the predetermination of the capture time or the capture time period. Once the record attributes have been determined, the search engine will search the metadata associated with the captured media content for the record attributes and if a match is found, the matching media content is compression encoded and stored.

At Event 206, at least a portion of the captured media content is compression encoded using a suitable audio or video compression codec. In aspects in which record attributes have been predetermined and a search performed, only the captured media content that meets the search criteria is compression encoded. In other aspects, in which no record attributes have been predetermined or the search function is not applicable, all of the captured broadcast media content is compression encoded. Compression encoding provides for the broadcast media content to be compressed in terms of the size of the media content so that less storage space is consumed in the recording/storage of the media content. In addition, compression encoding provides for an added measure of security in that the encoded media content is stored in an encrypted state. Examples, of audio compression codecs include, but are not limited to, MPEG (Motion Pictures Expert Group) Audio Layer III, commonly referred to as MP3, Advanced Audio Code (AAC), AAC+, eAAC+, HE-AAC, ITU-T G.711, ITU-T G.722, ITU-T G.722.1, ITU-T G722.2, ITU-T G.723, ITU-T G.723.1, ITU-T G.726, ITU-T G.729, ITU-T G.729a, FLAC, Ogg, Theora, Vorbis, ATRAC3, AC3, AIFF-C or the like. Examples of video compression codecs include, but are not limited to, MPEG-1 (Motion Pictures Expert Group), MPEG-2, MPEG-4, B.261, H.263, DivX, Sorenson 3, Theora, WMV (Windows Media Video), RealVideo, Cinepak and the like.

At Event 208, the compressed media content is stored (e.g., recorded). The media content may be stored locally at the wireless communication device or, in alternate aspects, may be wirelessly communicated to a network storage device, such as a media content server, for remote storage. Typically, remote storage is utilized if the warless communication device is limited in terms of storage capacity.

At Event 210, when the device user wishes to consume/play the recorded broadcast media content, the storage site is accessed, the media content is retrieved and the compressed broadcast media content is subjected to a decompression/decode process. In most aspects, the compression codec used to compress the broadcast media content is also implemented to decode/decompress the media content. At Event 212, once the media content has been decoded/decompressed, it is forwarded to the media player module for consumption/playing on the wireless communication device.

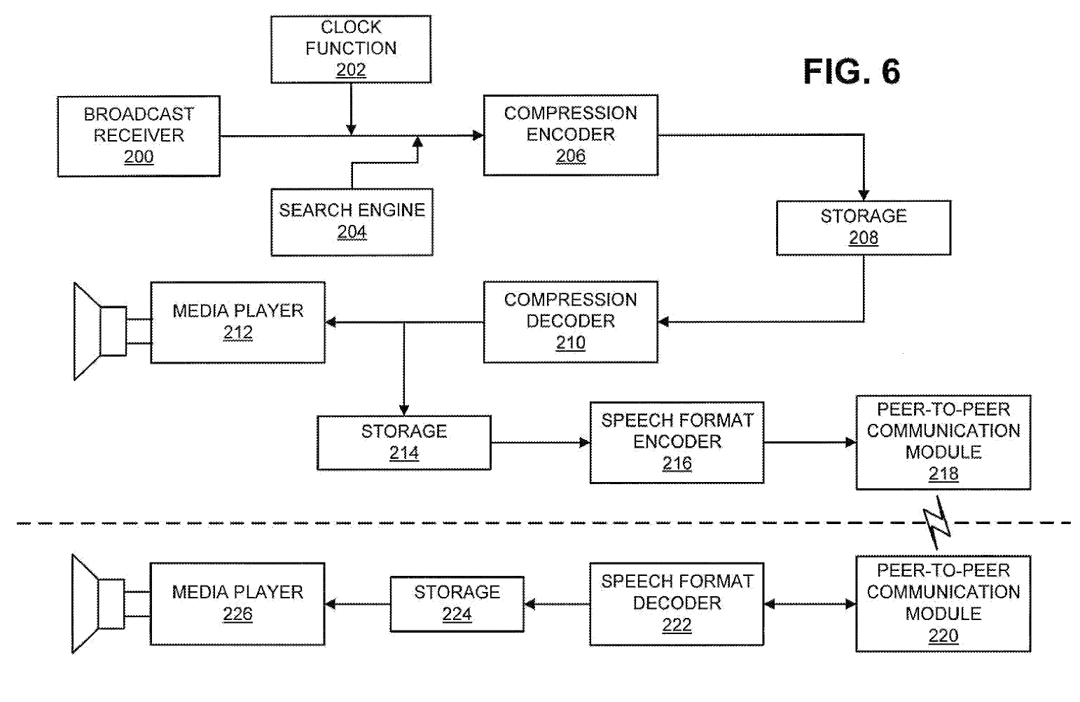

FIG. 6 is a flow diagram depicting a method for recording broadcast media content at a wireless communication device and the subsequent sharing of the recorded broadcast media content with another wireless communication device. In accordance with the FIG. 6 flow diagram, the user of the wireless device has designated the recorded broadcast media content for sharing with another wireless communication device. The user may designate the share recipient prior to capturing the broadcast media content. For example, the share recipient may be predetermined in conjunction with the predetermination of the capture time and/or the record attributes. In alternate aspects, the share recipient may be determined after the broadcast media content has been recorded at the wireless communication device. Events 200-212 were discussed in relation to FIG. 5 and, therefore, for the sake of brevity are not discussed in relation to FIG. 6.

At Event 214, the broadcast media content, which has been designated for sharing with another wireless communication device, is stored, typically temporarily, at the wireless communication device.

At Event 216, the broadcast media content is encoded in a speech-format. The speech-formatting of the broadcast content allows for certain communication networks to be used as the sharing vehicle, such as peer-to-peer communication networks. In addition, speech-formatting provides for the broadcast media content to be shared in a lesser audio quality format than the broadcasted media content. Speech format encoding is typically within the frequency range of about 20 hertz (Hz) to about 20 kilohertz (kHz). Examples of suitable speech codecs include, but are not limited to, QCELP (Qualcomm® Code Excited Linear Prediction), EVCR (Enhanced Variable Rate Codec), iLBC (Internet Tow Bit Rate), Speex and the like.

At Event 218, the speech-formatted broadcast media file is communicated to the share recipient. In one aspect, the wireless devices communicate via a multimedia peer (M2-Peer) communication network. At Event 220, the share recipient device receives the communication that includes the speech-formatted broadcast media content. The receiving device acknowledges that the communication is a media file requiring speech-format decoding.

At Event 222, the speech-formatted media file undergoes speech-decoding, resulting in a media file having speech-grade audio signals. As previously noted the speech-grade audio signals will have a frequency range of about 20 Hz to about 20 kHz. At Event 224, the speech-grade media content is stored. The media content may be stored locally at the wireless communication device or, in alternate aspects, may be wirelessly communicated to a network storage device, such as a media content server, for remote storage. Typically, remote storage is utilized if the wireless communication device is limited in terms of storage capacity. At Event 226, the storage site is accessed, and the media content is retrieved and forwarded to the media player for consumption/playing.

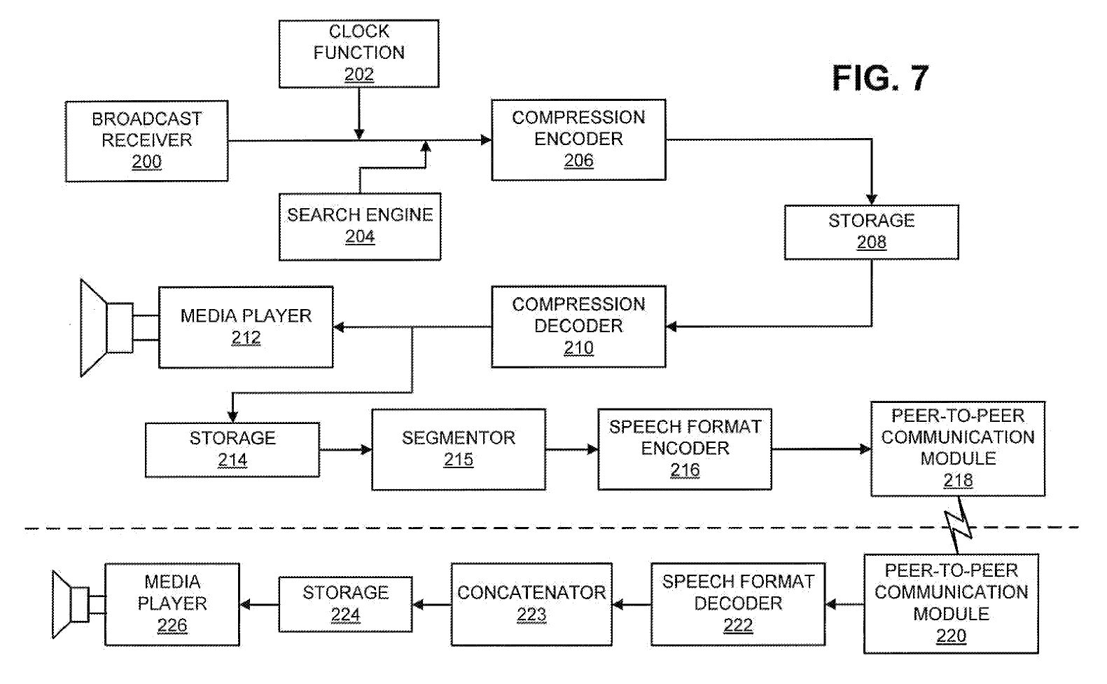

Referring to FIG. 7, a flow diagram is depleted of a method for recording broadcast media content and sharing the recorded broadcast media content with another wireless communication device. In the FIG. 7 method the media content is segmented at the recording device prior to sharing and, subsequently, concatenated at the sharing recipient wireless device. Segmentation is optionally performed in some aspects to accommodate media content size limitations in certain communication networks. For example, certain peer-to-peer communication networks are limited to communications that include audio files having a maximum length of about 60 to about 90 seconds. Events 200-214, 216-222 and 224-226 were discussed in relation to FIGS. 5 and 6 and, therefore, for the sake of brevity are not discussed in relation to FIG. 7.

At Event 215, the decoded media file is segmented prior to speech-format encoding the media file. Segmentation provides for each segment to be communicated to individually to the recipient device and, subsequently, concatenated to form the composite media file at the recipient device. The number of segments will vary depending on the size of the media file and the allowable length of a segment supported by the communication network. The header information associated with each media content segment will identify the sequence number of the segment and will be utilized at the receiving device for concatenation purposes. In alternate aspects, the segmentation process may occur after the media file has been speech-format encoded.

At Event 223, the speech-grade segments of the media file are concatenated to form the composite media file. In alternate aspects, the concatenation process may occur prior to the speech-format decoding process.

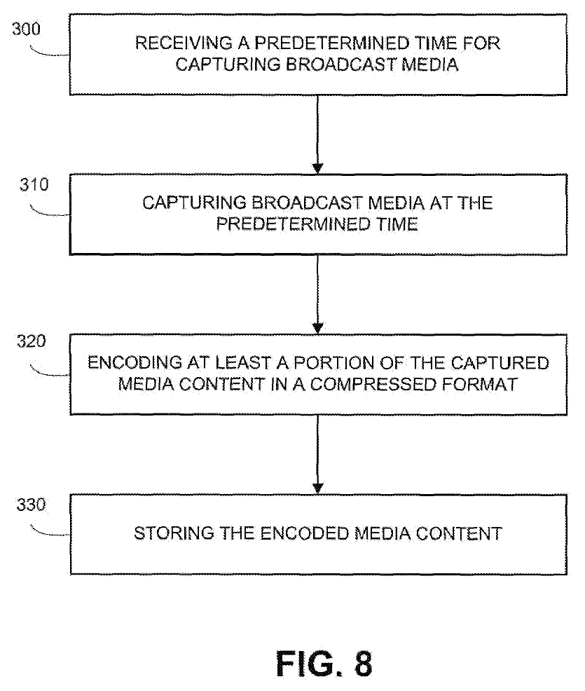

Referring to FIG. 8, a flow diagram of a method for recording broadcast media content at a wireless device is depicted. At Event 300, a wireless communication device receives a predetermined time for capturing broadcast media. In some aspects, a user pre-programs the wireless device to capture broadcast media at a future time or during a future time period. In addition to pre-programming the time for capturing broadcast media, the user may predefine the broadcast channel for which the content is to be captured from. In alternate aspects, a device user may choose to capture presently broadcasted media content, in which case, the predetermined time is the current time.

At Event 310, broadcast media content is captured at the predetermined time. In some aspects, capturing broadcast media will ensue upon launching or otherwise starting a broadcast recorder module executable on the wireless communication device. At Event 320, at least a portion of the captured broadcast media content is encoded in a compressed format. The broadcast media is captured in a first format associated with a first memory size and the compression encoding process results in a second format having a second memory size that is less than the first memory size for an equal portion of broadcast media content. In certain aspects, in which the captured media content is searched for specific record attributes, only those portions of the media content that match the record attributes are subjected to the compression encoding process. In other aspects, in which the search function is not utilized or is not applicable, all of the captured media content may be subjected to the compression encoding process.

At Event 330, once the media content has been compression encoded the broadcast media content is stored as a media content file. As previously noted, the media content file may be stored locally at the wireless communication device or, in alternate aspects; the media content file may be stored remotely at a wireless network device/server. The device user may access the storage site and retrieve the media content file for consumption/playing on a media player application executable at the wireless communication device.

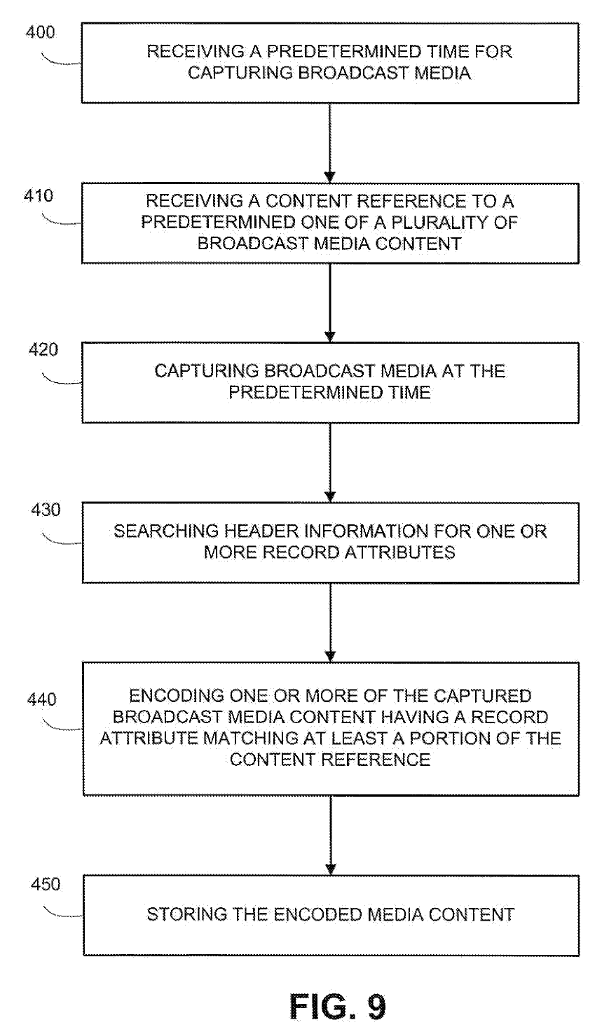

Referring to FIG. 9, a flow diagram is depicted of a method for searching captured broadcast media content for record attributes and recording broadcast media content that include the record attributes. At Event 400, a wireless communication device receives a predetermined time for capturing broadcast media. In some aspects, a user pre-programs the wireless device to capture broadcast media at a future time or during a fixture time period. In addition to pre-programming the time for capturing broadcast media, the user may predefine the broadcast channel for which the content is to be captured from. In alternate aspects, a device user may choose to capture presently broadcasted media content in which case, the predetermined time is the current time.

At Event 410, the wireless device receives a content reference to a predetermined one of a plurality of broadcast media content. The content reference is a unique identifier that associated with media content. For example, a program title, a song title, an artist or the like. In some aspects, the content identifier will be predetermined by the device user concurrently with the predetermination of the capture time.

At Event 420, the broadcast media content is captured at the predetermined time. In some aspects, capturing broadcast media will ensue upon launching or otherwise starting a broadcast recorder module executable on the wireless communication device. At Event 430, header information associated with captured media content is searched for record attributes that match file content identifier. For example, if the content identifier is the name of an artist, header information for all captured broadcast media content is searched for the artist's name. At Event 440, the captured broadcast media content having a record attribute that matches at least a portion of the content reference is compression encoded. As previously noted, the broadcast media is captured in a first format associated with a first memory size and the compression encoding process results in a second format having a second memory size that is less than the first memory size for an equal portion of broadcast media content.

At Event 330, once the captured broadcast media content has been compression encoded the broadcast media content is stored as a media content file. As previously noted, the media content file may be stored locally at the wireless communication device or, in alternate aspects; the media content file may be stored remotely at a wireless network device/server. The device user may access the storage site and retrieve the media content file for consumption/playing on a media player application executable at the wireless communication device.

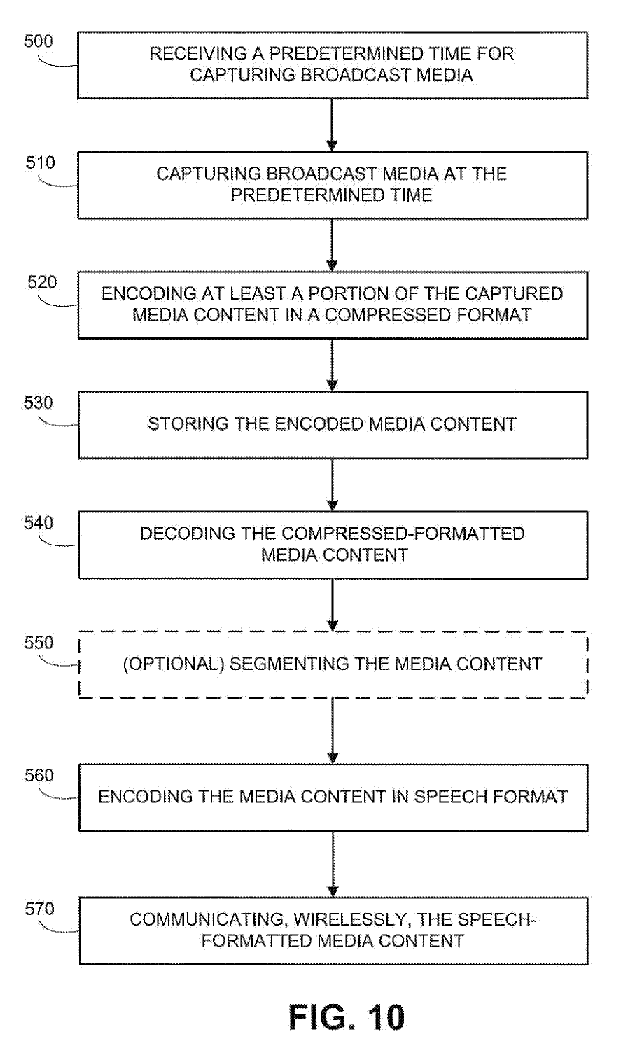

Referring to FIG. 10, a flow diagram of a method for recording broadcast media content and sharing the recorded media content with another wireless device is depicted. At Event 500, a wireless communication device receives a predetermined time for capturing broadcast media. In some aspects, a user pre-programs the wireless device to capture broadcast media at a future time or during a future time period. In addition to pre-programming the time for capturing broadcast media, the user may predefine the broadcast channel for which the content is to be captured from and in some aspects, pre-program one or more share recipients.

At Event 510, broadcast media content is captured at the predetermined time. In some aspects, capturing broadcast media will ensue upon launching or otherwise starting a broadcast recorder module executable on the wireless communication device. At Event 520, at least a portion of the captured broadcast media content is encoded in a compressed format. The broadcast media is captured in a first format associated with a first memory size and the compression encoding process results in a second format having a second memory size that is less than the first memory size for an equal portion of broadcast media content. In certain aspects, in which the captured media content is searched for specific record attributes, only those portions of the media content that match the record attributes are subjected to the compression encoding process. In other aspects, in which the search function is not utilized or is not applicable, all of the captured media content may be subjected to the compression encoding process.

At Event 530, once the media content has been compression encoded the broadcast media content is stored as a media content file. As previously noted, the media content file may be stored locally at the wireless communication device or, in alternate aspects; the media content file may be stored remotely at a wireless network device/server.

At Event 540, the compressed media content is decoded, resulting in decompressed media content and, at optional Event 550, the decompressed media file may be segmented into two or more segments or media clips. In certain aspects, segmenting may be necessary to accommodate the size limitations of certain communication networks. As illustrated, segmentation may occur prior to speech-encoding the broadcast media file or, in alternate aspects, segmentation may occur after the media file has been speech-encoded.

At Event 560, the decompressed and, in some aspects, segmented media content is encoded in a speech format. Speech formatting allows for certain communication networks to be implemented as the sharing communication network. Additionally, speech-formatting degrades the audio quality of the media content to a level that may be deemed acceptable in terms of sharing. At Event 570, the speech-formatted broadcast media file is wirelessly communicated to the designated share recipients. In some aspects, the broadcast media files are communicated via a peer-to-peer network, such as a multimedia peer (M2-Peer) communication network.

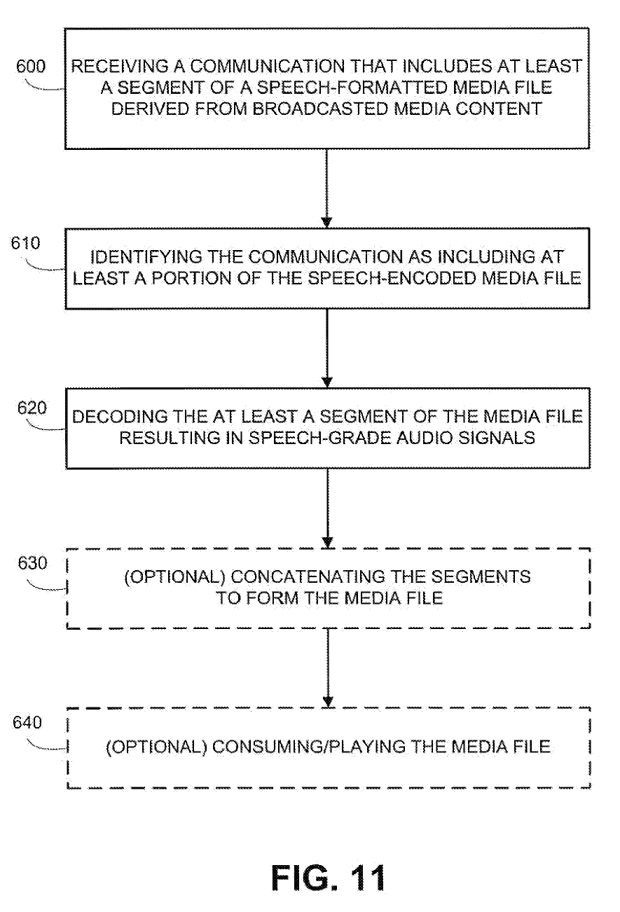

Referring to FIG. 11, a method for receiving shared broadcast media files at a wireless communication device is depicted. At Event 600, a wireless communication device receives a communication that includes at least a segment of a speech-formatted media file derived from broadcast media content. In some aspects, the device will receive a single communication that includes the entire media file and, in other aspects, the communication device will receive multiple communications with each communication including a segment of the media file. In certain aspects, the communication will be received via a peer-to-peer communication network, such as a multimedia peer (M2-Peer) network communication.

At Event 610, the communication is identified as including at least a portion of the speech-encoded media file. Identification of the content of the communication is required to insure that the communication is properly routed to a speech-decompression codec and subsequently to a media player application. At Event 620, the speech-formatted media file is decoded resulting in a media file with speech-grade audio signals.

At optional Event 620, if the communication included a segment of a media file, the segments are concatenated, in sequence, to form the composite media file. In alternate aspects, concatenation of the segments of the media file may occur prior to decoding of the media file. At optional Event 630, the decoded and, optionally concatenated media file is transmitted to the media player application for consumption/playing.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method of algorithm may reside as one or any combination or set of instructions on a machine-readable medium and/or computer readable medium.

While the foregoing disclosure shows illustrative aspects, and/or embodiments, it should be noted that various changes and modifications could be made herein without departing from the scope of the described aspects and/or embodiments as defined by the appended claims. Furthermore, although elements of the described embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

Thus, present aspects provide for methods, apparatus, computer program products, processors and the like that record broadcast media content at a wireless communication device and, in some aspects, share the recorded broadcast media content with other wireless communication devices. The disclosed aspects capture broadcasted media content, such as radio or television broadcasted content at predetermined times. In this regard, a clock function resident on the wireless communication device launches the capture and record module at the predetermined time. The captured media content is then encoded in a compressed format readily conducive to the memory limitations typical of a wireless communication device. In certain aspects, the device incorporates a search function that allows for the predetermined selection of media content criteria that is used to search and determine the media content that is encoded and stored for subsequent use and/or sharing. In other aspects, the recorded broadcast media content is shared with other wireless communication devices by encoding the recorded/stored media content in a speech-format and communicating the speech-formatted media content to other wireless devices, typically via a multimedia peer (M2-Peer) network.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for recording broadcast media content at a wireless communication device, comprising:
receiving a predetermined time for capturing broadcast media content;
capturing broadcast media content at the predetermined time, the captured broadcast media content comprising a first format that requires a first memory size;
encoding at least a portion of the captured broadcast media content in a second format, the second format requiring a second memory size, wherein the second memory size is less than the first memory size for an equal portion of broadcast media content; and
storing the encoded broadcast media content.

2. The method of claim 1, further comprising receiving a content reference to a predetermined one of a plurality of broadcast media content, wherein encoding further comprises searching header information associated with the captured broadcast media content for one or more record attributes and encoding one or more of the plurality of broadcast media content having a record attribute matching at least a portion of the content reference.

3. The method of claim 1, further comprising:
decoding the stored broadcast media content from the second format to a third format requiring a third memory size, wherein the third memory size is greater than the second memory size for an equal portion of broadcast media content;
encoding, in a speech format, the decoded broadcast media content; and
communicating the speech-formatted broadcast media content to another wireless communication device.

4. The method of claim 3, wherein communicating further comprises transmitting over a multimedia peer (M2-Peer) communication network.

5. The method of claim 3, wherein the third format comprises the first format.

6. The method of claim 3, further comprising determining the other communication device prior to capturing the broadcast media content.

7. The method of claim 3, further comprising segmenting the decoded broadcast media content into two or more media clips.

8. The method of claim 7, wherein communicating further comprises communicating, individually, the two or more, speech-formatted, media clips to another wireless communication device.

9. The method of claim 1, wherein capturing further comprises receiving broadcast media content in a format corresponding to a format executable by a media player resident on the wireless device.

10. The method of claim 1, wherein capturing further comprises awakening a media application on the wireless device at the predetermined time and listening for the broadcast media content.

11. The method of claim 1, wherein the broadcast media content comprises radio waves within the frequency range of about 88 megahertz (MHz) to about 108 MHz.

12. The method of claim 1, wherein the broadcast media content comprises radio waves within the frequency range of about 535 kilohertz (kHz) to about 1605 kHz.

13. The method of claim 1, wherein the broadcast media content comprises television waves within the frequency range of about 30 megahertz (MHz) to about 3000 MHz.

14. The method claim 1, wherein receiving further comprises receiving a selection of one of a plurality of predetermined times associated with desired broadcast media content.

15. The method of claim 1, wherein storing further comprises storing the encoded broadcast media content at the wireless communication device.

16. The method of claim 1, wherein storing further comprises storing the encoded broadcast media content remotely at a wireless network device.

17. At least one processor configured to perform the actions of:
receiving a predetermined time for capturing broadcast media content;
capturing broadcast media content at the predetermined time, the captured broadcast media content comprising a first format that requires a first memory size;
encoding at least a portion of the captured broadcast media content in a second format, the second format requiring a second memory size, wherein the second memory size is less than the first memory size for an equal portion of broadcast media content; and
storing the encoded broadcast media content.

18. A machine-readable medium comprising instructions stored thereon, comprising:
a first set of instructions for receiving a predetermined time for capturing broadcast media content;
a second set of instructions for capturing broadcast media content at the predetermined time, the captured broadcast media content comprising a first format that requires a first memory size;
a third set of instructions for encoding at least a portion of the captured broadcast media content in a second format, the second format requiring a second memory size, wherein the second memory size is less than the first memory size for an equal portion of broadcast media content; and
a fourth set of instructions for storing the encoded broadcast media content.

19. A wireless communication device, the device comprising:
a computer platform including at least one processor and a memory;
a broadcast receiver stored in the memory and executable by the processor, wherein the broadcast receiver is capable of receiving broadcast media content;
a broadcast recorder module stored in the memory and executable by the processor, wherein the broadcast recorder module is operable for capturing and storing broadcasted media content;
a clock function stored in the memory and executable by the processor, wherein the clock function is operable for launching the broadcast recorder module at a predetermined time to capture broadcasted media content; and
a media compression codec stored in the memory and executable by the processor, wherein the media compression codec is operable for encoding at least a portion of the captured broadcasted media content from a first format that requires a first memory size to a second format that requires a second memory size and wherein the second memory size is less that the first memory size for an equal portion of the broadcast media content.

20. The wireless communication device of claim 19, wherein the broadcast recorder module is further operable for receiving the predetermined time for launching the module.

21. The wireless communication device of claim 19, wherein the broadcast recorder module further comprises a search engine operable for searching header information associated with the broadcasted media content to identify a predetermined record attribute.

22. The wireless device of claim 21, wherein the broadcast recorder module is further operable to encode broadcast media content if the media content includes the predetermined record attribute.

23. The wireless communication device of claim 19, further comprising a speech vocoder operable for encoding the stored broadcasted media content in a speech format.

24. The wireless communication device of claim 23, further comprising a multimedia peer (M2-Peer) communication module operable for communicating the speech-formatted media content to another wireless communication device.

25. The wireless communication device of claim 23, wherein the speech format is further defined as an audio format in the bandwidth range of about 20 hertz (Hz) to about 20 kilohertz (kHz).

26. The wireless communication device of claim 24, wherein the broadcast recorder module is further operable for determining the other wireless communication device prior to capturing the broadcast media content.

27. The wireless communication device of claim 19, further comprising a segmentor operable for segmenting the captured broadcast media content into two or more media clips.

28. The wireless communication device of claim 27, further comprising a multimedia peer (M2-Peer) communication module operable for individually communicating the two or more media clips to another wireless communication device.

29. The wireless communication device of claim 27, wherein the broadcast receiver is further operable for receiving radio waves within the frequency range of about 88 megahertz (MHz) to about 108 MHz.

30. The wireless communication, device of claim 27, wherein the broadcast receiver is further operable for receiving radio waves within the frequency range of about 535 kilohertz (kHz) to about 1605 kHz.

31. The wireless communication device of claim 27, wherein the broadcast receiver is further operable for receiving television waves within the frequency range of about 30 megahertz (MHz) to about 3000 MHz.

32. A wireless communication device, the device comprising:
means for receiving a predetermined time for capturing broadcast media content;
means for capturing broadcast media content at the predetermined time, the captured broadcast media content comprising a first format that requires a first memory size;
means for encoding at least a portion of the captured broadcast media content in a second format, the second format requiring a second memory size, wherein the second memory size is less than the first memory size for an equal portion of broadcast media content; and
means for storing the encoded broadcast media content.

33. A method for receiving shared broadcasted media content at a wireless communication device, the method comprising:
receiving a communication at a wireless communication device, wherein the communication includes at least a segment of a media file comprising speech-formatted, broadcast media content;
identifying the communication as including at least a segment of the media file; and
decoding the at least a segment of the media file from a first format to a second format, wherein the second format includes speech-grade audio signals.

34. The method of claim 33, wherein receiving further comprises receiving a Multimedia Peer (M2-Peer) communication at a wireless communication device.

35. The method of claim 33, wherein receiving a communication further comprises receiving two or more communications, wherein each communication includes a segment of the media file.

36. The method of claim 35, further comprising concatenating the decoded segments of the media file to form a composite media file.

37. The method of claim 33, further comprising transmitting the decoded media file to a media player application.

38. The method of claim 33, wherein decoding further comprises decoding the media file from a first format to a second format, wherein the second format includes speech-grade audio signals having a frequency bandwidth of about 20 hertz (Hz) to about 20 kilohertz (kHz).

39. At least one processor configured to perform the actions of:
receiving a communication at a wireless communication device, wherein the communication includes at least a segment of a media file comprising speech-formatted, broadcast media content;
identifying the communication as including at least a segment of the media file; and
decoding the at least a segment of the media file from a first format to a second format, wherein the second format includes speech-grade audio signals.

40. A machine-readable medium comprising instructions stored thereon, comprising:
a first set of instructions for receiving a communication at a wireless communication device, wherein the communication includes at least a segment of a media file comprising speech-formatted, broadcast media content;
a second set of instructions for identifying the communication as including at least a segment of the media file; and
a third set of instructions for decoding the at least a segment of the media file from a first format to a second format, wherein the second format includes speech-grade audio signals.

41. A wireless communication device, the device comprising:
a computer platform including at least one processor and a memory; and
a communication module stored in the memory and executable by the processor, wherein the communication module is operable for receiving a communication and identifying the communication as including at least a segment of a media file that comprises speech-formatted, broadcast media content; and
a speech vocoder stored in the memory and executable by the processor, wherein the speech vocoder is operable for decoding the media file from a first format to a second format, wherein the second format includes speech-grade audio signals.

42. The wireless communication device of claim 41, wherein the communications module is further defined as a Multimedia Peer (M2-Peer) communication module operable for receiving a M2-Peer communication.

43. The wireless communication device of claim 41, further comprising a concatenator stored in the memory and executable by the processor, wherein the concatenator is operable for concatenating the segments to form the media file.

44. The wireless communication device of claim 41, further comprising a media player application that is operable for receiving and executing the second formatted media file.

45. The wireless communication device of claim 44, wherein the media player application includes a concatenator operable for concatenating the segments to form the media file.

46. A wireless communication device, the device comprising:
means for receiving a communication at a wireless communication device, wherein the communication includes at least a segment of a media file comprising speech-formatted broadcast media content;
means for identifying the communication as including at least a segment of the media file; and
means for decoding the media file from a first format to a second format, wherein the second format includes speech-grade audio signals.
